(19) United States
(12) Patent Application Publication
(10) Pub. No.: US 2011/0238781 A1
(43) Pub. Date: Sep. 29, 2011

(54) AUTOMATED TRANSFER OF BULK DATA INCLUDING WORKLOAD MANAGEMENT OPERATING STATISTICS

(76) Inventors: Justin A. Okun, Lake Forest, CA (US); Raju Yadava, Rohini Delhi (IN)

(21) Appl. No.: 12/731,371

(22) Filed: Mar. 25, 2010

(51) Int. Cl. G06F 15/16; G06F 17/30

(52) U.S. Cl. 709/217; 707/803; 707/E17.005

(57) ABSTRACT

Methods and systems for transferring bulk data, such as workload operation statistics, are disclosed. One method includes communicatively connecting a first computing system to a second computing system that stores bulk data, and determining a subset of the bulk data to be requested. The method further includes forming one or more extraction ranges representing the subset of the bulk data. For each of the one or more extraction ranges, the method includes transmitting a request for data including an identification of the extraction range, and receiving a data block defined by the extraction range and extracted from the bulk data.

### TECHNICAL FIELD

The present application relates generally to management and transfer of bulk data for analysis. In particular, the present application relates to automated transfer of workload management operating statistics.

### BACKGROUND

Computing systems that are configured to host a large number of workloads typically create a log of usage statistics, including information about the workloads hosted, time elapsed for execution of each workload and allocation of resources relating to those workloads. The log can also include specific statistics or operational characteristics of the host computing system. The log can, in certain circumstances, reflect transactions occurring over the past month or year at the host computing system.

Traditionally, the statistics for a host computing system are collected in a file on that system. That file can be requested and obtained by another computing system for review and analysis of the performance of that hosting computing system. In current statistics gathering arrangements, the logged workload statistics are stored as a binary file or XML file. That file can be downloaded to an analysis computing system, and loaded into memory to be parsed for analysis and reporting, e.g., creation of graphical reports based on the statistical data.

This arrangement has a number of drawbacks. For example, each time updated statistics are desired, an analysis computing system must manually request and receive a log file of the statistics for a host computing system for a range of time. The data returned for that range of time is returned as a single data block, regardless of the size of the block or amount of time involved. Additionally, each time a file is opened for use at the analysis computing system from a host computing system, that entire file is parsed for analyzing desired information, even when only a portion of that file is needed. Furthermore, existing analysis tools require a single file from which to generate reports; therefore, multiple files of a shorter timeframe could not be used to work around the lengthy parsing of a single log file.

Additionally, this arrangement becomes complex and computationally intensive when an analysis computing system requests usage information from more than one host computing system, and when the logged information at each host becomes voluminous (e.g., multiple gigabytes of information per log file). Generating a report by traversing each of the voluminous log files from each host requires a large amount of time. Additionally, if an error is detected during transmission of such a large file, typically the entire file must be retransmitted, which results in inefficiencies because the vast majority of the file would be error free, but would nevertheless be required to be retransmitted from the host computing system to the analysis computing system.

For these and other reasons, improvements are desirable.

### SUMMARY

In accordance with the present disclosure, the above and other problems are addressed by the following:

In a first aspect, a method of transferring bulk data is disclosed. The method includes communicatively connecting a first computing system to a second computing system, the second computing system storing bulk data, and determining a subset of the bulk data to be requested by the first computing system. The method further includes forming one or more extraction ranges representing the subset of the bulk data. For each of the one or more extraction ranges, the method includes transmitting a request for data from the first computing system to the second computing system, the request for data including an identification of the extraction range. The method also includes receiving a data block from the second computing system, the data block defined by the extraction range and extracted from the bulk data.

In a second aspect, a system for obtaining data from a host computing system is disclosed. The system includes an analysis computing system communicatively connected to the host computing system, the analysis computing system including a memory configured to store one or more database files. The analysis computing system is configured to communicatively connect the analysis computing system to the host computing system, the host computing system storing bulk data. The analysis computing system is also configured to determine a subset of the bulk data to be requested system, and form one or more extraction ranges representing the subset of the bulk data. For each of the one or more extraction ranges, the analysis computing system is configured to transmit a request for data to the host computing system, the request for data including an identification of the extraction range, and receive a data block from the host computing system, the data block defined by the extraction range and extracted from the bulk data. The analysis computing system is also configured to, upon receipt of all of the data blocks from the host computing system, store the data blocks in the database file.

In a third aspect, a system for obtaining data relating to workload operating statistics is disclosed. The system includes a plurality of host computing systems each storing a log file of workload operating statistics of that host computing system. The system also includes an analysis computing system communicatively connected to the plurality of host computing systems, the analysis computing system including a memory configured to store one or more database files. The analysis computing system is configured to communicatively connect to each of the plurality of host computing systems, each host computing system storing a log file including workload operating statistics. The analysis computing system is also configured to determine a subset of the workload operating statistics to be requested system, and form one or more extraction ranges representing the subset of the workload operating statistics. For each of the one or more extraction ranges and each of the host computing systems, the analysis computing system is configured to transmit a request for data to the host computing system, the request for data including an identification of the extraction range, and receive a data block from the host computing system, the data block defined by the extraction range and extracted from the log file. The analysis computing system is further configured to store the data block in a database file at the analysis computing system, the database file thereby containing workload operating statistics for a plurality of host computing systems.

### BRIEF DESCRIPTION OF THE DRAWINGS

FIG. 1 is a schematic depiction of an example network in which aspects of the present disclosure can be implemented;

FIG. 2 is a schematic depiction of a portion of the example network of FIG. 1 illustrating transfer of bulk data between computing systems;

FIG. 3 is a logical block diagram of an analysis computing system that can implement a bulk data retrieval system, according to a possible embodiment of the present disclosure;

FIG. 4 is a block diagram illustrating example physical components of an electronic computing device useable to implement the various methods and systems described herein;

FIG. 5 is a flowchart of methods and systems for automated transfer of block data, according to a possible embodiment of the present disclosure;

FIG. 6 is a flowchart of operation of a data extraction process useable according to a possible embodiment of the present disclosure; and

FIG. 7 is a flowchart of further operation of the data extraction process of FIG. 6.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for transfer, including automated transfer, of bulk data such as workload management operating statistics. The methods and systems described herein allow incremental extraction and download of bulk data from a remote system, while tracking the incremental transfer of that data to provide for error recovery with reduced overhead. In the context of collection of workload statistics, the methods and systems of the present disclosure allow handling of data across a large timeframe (e.g., gigabytes of data collected over one or more years of operation of a system) for collation and integration into a repository. That collated and collected information can be retrieved from a number of hosts or other computing systems, and reports can be generated based on the information retrieved (i.e., the information of interest for analysis).

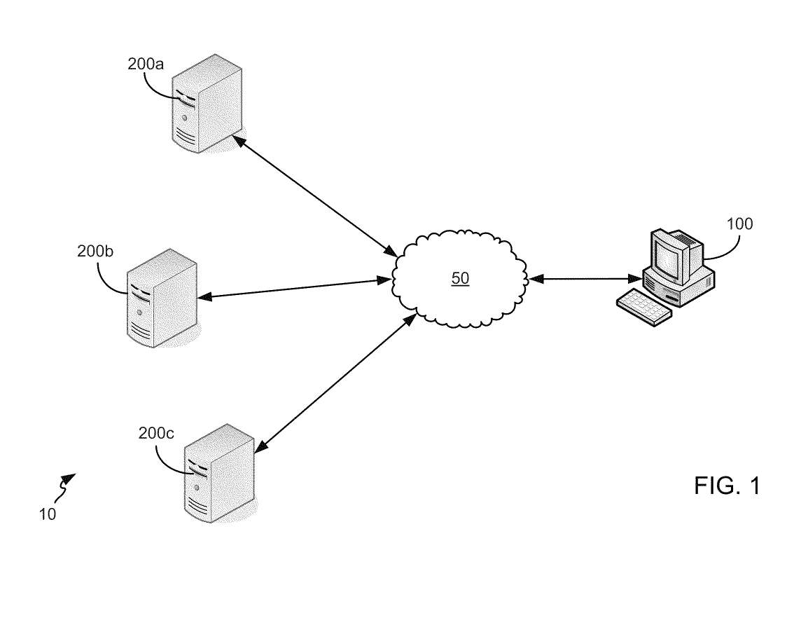

FIG. 1 is a schematic depiction of an example network 10 in which aspects of the present disclosure can be implemented. The network 10 includes a communicative connection 50 connecting an analysis computing system 100 with a plurality of host computing systems 200, illustrated as systems 200a-c.

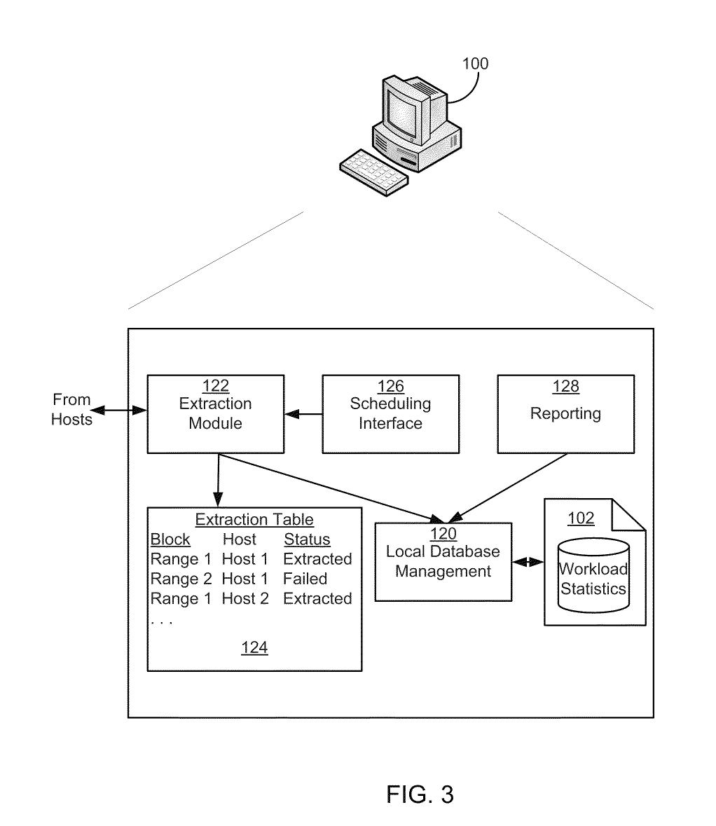

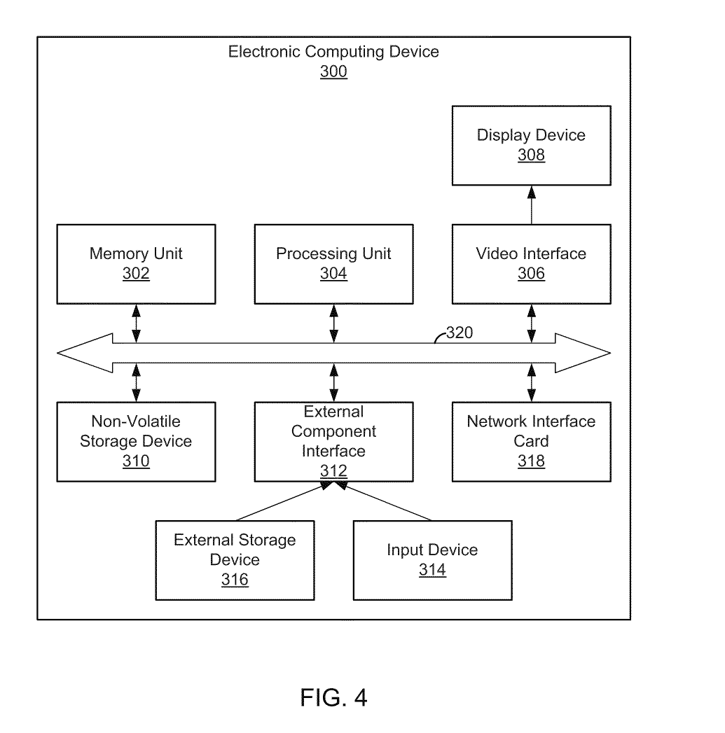

The analysis computing system 100 is a system capable of managing receipt and indexing of bulk data. In certain embodiments, the analysis computing system 100 hosts scheduling and reporting functionality, such that the system is capable of automating download of the bulk data at predetermined times (e.g., daily, weekly, monthly, etc.) from one or more of the host computing systems 200a-c, or scheduling different downloads of different amounts and selections of data from the host computing systems. In such embodiments, the analysis computing system 100 stores that data in a database file for access and generating reports relating to operation of the host computing systems 200a-c. Some examples of hardware and functional blocks associated with a possible analysis computing system are illustrated in FIGS. 3-4, described below.

The host computing systems 200a-c correspond generally to server systems capable of hosting one or more workloads and monitoring operation of those workloads (e.g., for reporting and billing purposes). In certain embodiments, one or more of the host computing systems can operate using the Clearpath MCP operating system provided by Unisys Corporation of Blue Bell, Pennsylvania. During operation, the host computing systems 200a-c typically execute workloads scheduled for operation on those systems, and monitor various statistics relating to those workloads. For extraction, the host computing systems 200a-c typically execute a background application capable of receiving requests from the analysis computing system 100 and returning data within an extraction range defined by a request from the analysis computing system, as further explained below.

The communicative connection 50 can be any of a number of types of networks, such as the Internet, a private network, or other type of communicative connection.

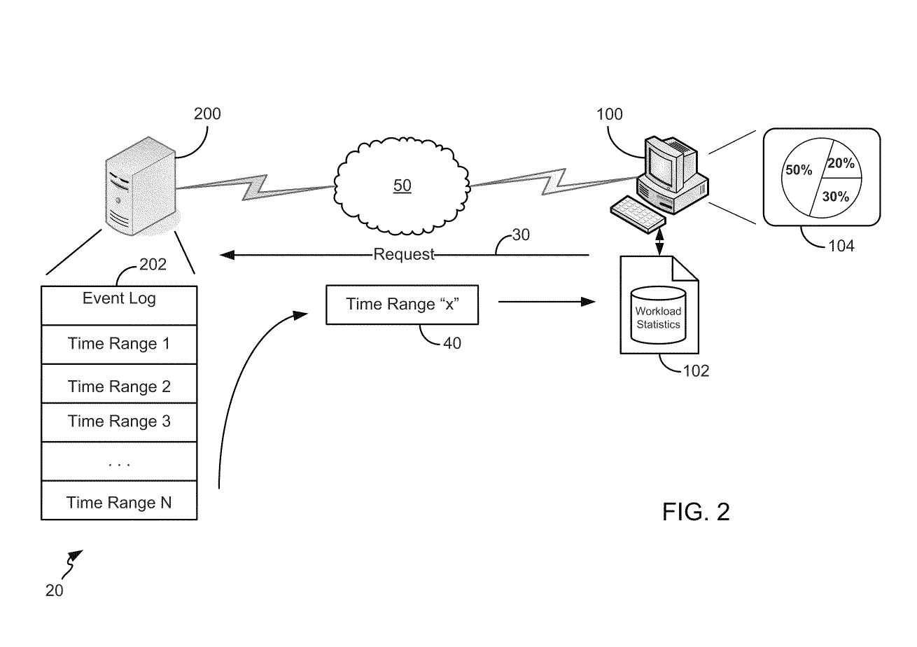

FIG. 2 is a schematic depiction of a subnetwork 20 portion of the example network 10 of FIG. 1, illustrating transfer of bulk data between computing systems. The subnetwork 20 is intended to illustrate one possible example implementation of the bulk data transfer according to certain embodiments of the present disclosure in which the bulk data corresponds to workload operating statistics. The subnetwork 20 includes the analysis computing system 100 and a host computing system 200, at which the workload operating statistics are initially observed and gathered.

The host computing system 200 stores an event log 202, which can include workload operating statistics for a long period of time (e.g., days, weeks, months, or years). A wide variety of such statistics could be gathered in the event log 202. For example, workload statistics can be gathered such as the elapsed time a workload runs, the percentage uptime of the workload, the resources consumed by the workload (e.g. processor, memory, or communication bandwidth), average resources consumed by the workload, events generated by the workload, or any errors observed as occurring due to the workload. Other operational statistics can be gathered as well. These operational statistics can be stored in a log file or other file based structure (e.g., binary or XML formats) for review and processing as required. The event log 202 is, in certain embodiments, organized sequentially in time, such that various time slices (e.g., subsections of the event log) are organized and able to be selected such that a contiguous time period corresponds to a contiguous portion of the event log. In the embodiment shown, the event log or a portion thereof corresponds to the bulk data to be transferred to the analysis computing system 100.

As illustrated in the subnetwork 20, bulk data transfer is generally initiated by a request 30 from the analysis computing system 100 to the desired host computing system 200. The request 30 includes an identification of a particular portion of the event log 202 to be returned to the analysis computing system 100. The host computing system 200 can, upon receipt of the request 30, extract a data block 40 from the event log 202 that corresponds to the identified portion of the log, and transmit that data block to the analysis computing system 100. As further described below, the request 30 relates to a predetermined size data block 40, for example a predetermined elapsed period of time during which workload operating statistics are gathered.

The analysis computing system 100 includes a database file 102 capable of indexing and storing the received data blocks 40. In certain embodiments, the database file is stored using a database schema arranged by record type and indexed by timestamp. Other database schemas are useable as well. In some embodiments, the database file can be managed using the SQLite in-process library that provides a serverless, self-contained transactional SQL database engine. Other embodiments can use a compact or desktop version of SQL Server database management services, such as SQL Server Compact, from Microsoft Corporation of Redmond, Wash. Other desktop database management services could be used as well.

In the embodiment shown in FIG. 2, event log 202 is arranged sequentially, so that it can be viewed as a number of time ranges, labeled “Time Range 1” through “Time Range N”. It is noted that the event log 202 is not in fact segmented into multiple time ranges but is instead a contiguous file from which segments can be extracted. If a user of the analysis computing system 100 wishes to analyze workload operating statistics over a period of time greater than the predetermined period of time defined by the time ranges, multiple serially-executed requests and responsive data blocks can be transmitted between the analysis computing system 100 and the host computing system 200. For example, if analysis is to be performed on a range including Time Range 2 and Time Range 3, a first request 30 can include an identification of Time Range 2, and responsive data block 40 can be provided to the analysis computing system 100 containing that portion of event log 202. After that data block is received and stored in the database file, a subsequent request identifying Time Range 3 can be sent to the host computing system 200, and a second responsive data block 40 can be returned including that data from the event log 202. In certain embodiments of the present disclosure, the time ranges are segmented into four hour blocks of time; in alternative embodiments, the time ranges could be segmented into one hour blocks, or other time ranges. By dividing requests of bulk data into requests for smaller data blocks, a larger number of data blocks must be requested, transferred, and indexed in the database file, while dividing the requested bulk data into larger data blocks results in use of fewer data blocks, but fewer requests and transfers to obtain the same range of bulk data.

Additionally, the analysis server 100 includes a reporting feature 104 capable of generating one or more reports based on the information contained in the database file 102. Various reporting systems can be used, and various reports can be generated. In a particular embodiment, the reporting feature 104 is performed using Statistics Viewer, a reporting tool capable of generating graphical reports useable for analysis of workload statistics that is provided by Unisys Corporation of Blue Bell, Pa.

FIG. 3 is a logical block diagram of an analysis computing system 100 that can implement a bulk data retrieval system, according to a possible embodiment of the present disclosure.

The analysis computing system 100 in the embodiment shown includes a local database management module 120 that manages the database file 102. The local database management module 120 provides local database management of the database file 102, and can be, in various embodiments, The database file 102 retains data, such as workload operating statistics, in an arrangement in which bulk data received from a number of host computing systems is segmented and indexed, as discussed above.

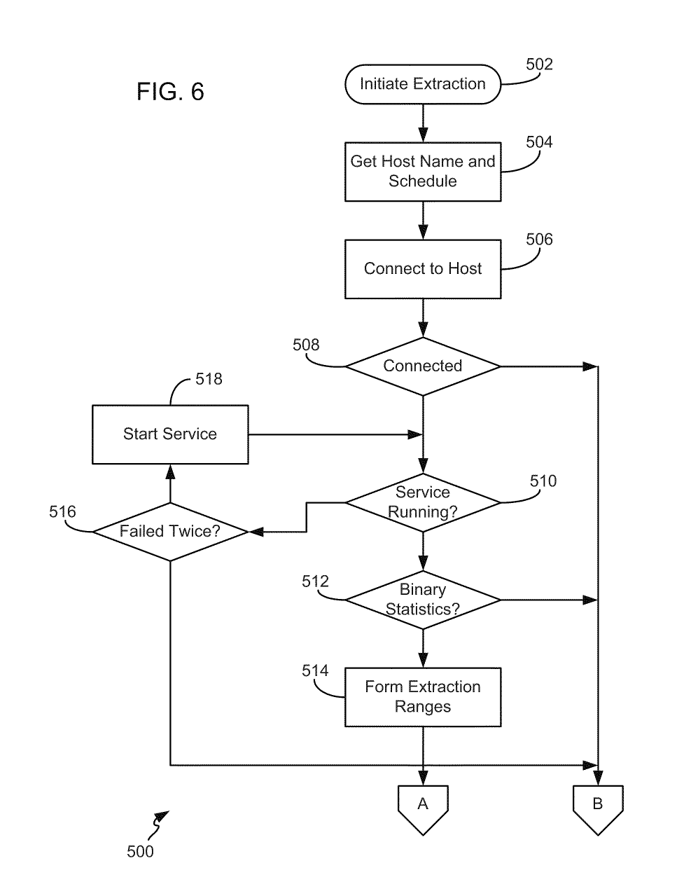

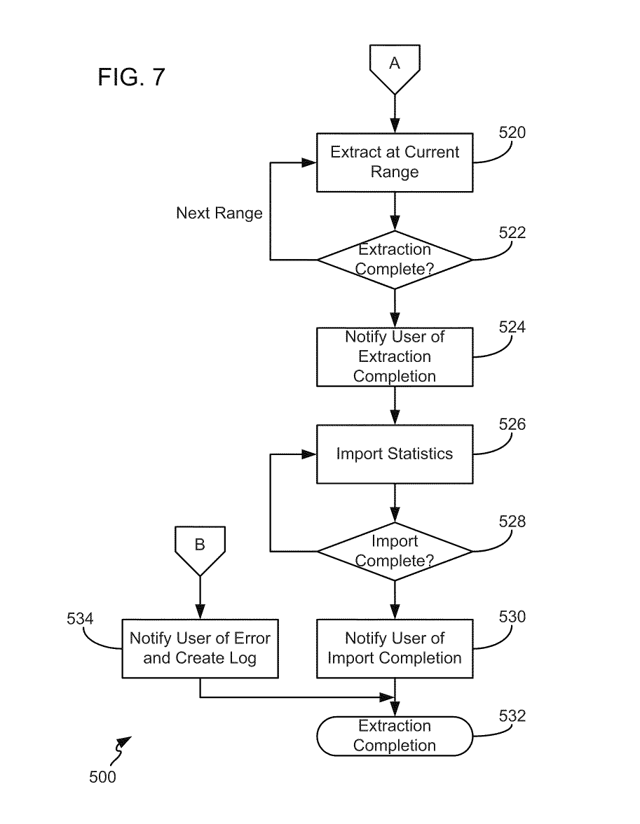

An extraction module 122 is interfaced to the local database management module 120, and manages extraction of the bulk data from each of a number of host computing systems to which the analysis computing system 100 is interfaced (e.g., host computing systems 200a-c of FIG. 1). The extraction module 122 can, in certain embodiments, operate using the methods described below in connection with FIGS. 6-7.

An extraction table 124 is managed by the extraction module 122, and tracks data blocks extracted and received from host computing system. The extraction table can contain any of a number of types of information relating to the extraction process. In certain embodiments, the extraction table contains information about an extraction session such as and extraction identifier, a start and end time and date for the extraction (e.g., the extraction range associated with a block), a last download date-time, and a message relating to when extraction of that range has begun (e.g., for communication to a user of the analysis computing system). Other information can be tracked as well, in the same or additional extraction tables. For example, additional information regarding the name of the binary file (data block) to be imported into the database, the start and end time (extraction range) of the data in the binary file. In additional embodiments, certain data blocks in which errors are observed are skipped, to be retried in the future. In such an instance, the extraction table 124 can track the start and end time (extraction range) for those data blocks, as well as the number of times that extraction of that data block has been attempted for that block. Other information can be tracked as well.

As the extraction module 122 requests and receives data blocks extracted from bulk data at host computing systems, the extraction module can update the various fields of the extraction table 124 to retain the status of the extraction performed. Once the extraction of a group of data blocks is performed, the extraction module 120 can retry failed extractions (e.g., extractions in which the returned data blocks contain errors) based on the information in the extraction table 124.

The received data blocks obtained by the extraction module 122 can be passed to the local database management module 120 for storage in the database file 102 either (1) as received, or (2) upon completion of extraction of an entire extraction, which could include one or more data blocks and extraction ranges. Upon completion (or interruption) of an extraction of a selected number of extraction ranges, the extraction module 122 can generate a message relating to the manner of completion of the extraction (e.g., completion or interruption). The extraction module 122 can, in certain embodiments, present messages to a user via a user interface to communicate the status of an extraction of bulk data. For example, the extraction module can provide an indication to a user each time a block of data is successfully retrieved from a host computing system, each time an error is detected, or when a scheduled extraction is complete. Other messages can be generated by the extraction module 122 as well.

In the embodiment shown, a scheduling module 126 allows a user to select a time period in which extract new information from a host computing system. The scheduling module 126 is operatively connected to the extraction module 122 and can direct the extraction module to initiate an extraction from one or more host computing systems. For example, the scheduling module 126 can provide a user interface allowing a user to define an amount of data to manually extract form a host computing system, or an amount of data to automatically extract at a predetermined time. For automatic extraction, the scheduling module 126 can allow the user to define a particular time of day or day of the week or month to perform the desired extraction. This time of day or day of the week preferably corresponds to a time at which the host computing system is experiencing reduced usage, and where communications bandwidth is at or near a utilization minimum.

Reporting module 128 interfaces to the local database management module 120, and allows user creation of reports based on at least a portion of the information stored in the database file 102. The reporting module 128 can generate any of a number of reports relating to the data, for example relating to workload operating statistics. The operating statistics can be displayed in custom reports over any of a number of ranges (e.g., annual, quarterly, or monthly operating statistics. Other methods of generating reports based on those operating statistics are possible as well. As previously described, the reporting module 128 can, in certain embodiments, correspond to at least a portion of Statistics Viewer, a reporting tool capable of generating graphical reports useable for analysis of workload statistics that is provided by Unisys Corporation of Blue Bell, Pennsylvania. Other reporting software packages could be used as well.

When used alongside the methods and systems described herein, the reporting module 128 can request information from the local database management module 120 as required to create the report desired by a user, rather than requesting and parsing an entire file to obtain the data required to create the report. The local database management module 120 can obtain the desired information by processing the indexed data to provide only the data requested, reducing overhead for both data receipt and analysis.

FIG. 4 is a block diagram illustrating example physical components of an electronic computing device 300, which can be used to execute the various operations described above, and can be any of a number of the devices described in FIG. 1 and including any of a number of types of communication interfaces as described herein. A computing device, such as electronic computing device 300, typically includes at least some form of computer-readable media. Computer readable media can be any available media that can be accessed by the electronic computing device 300. By way of example, and not limitation, computer-readable media might comprise computer storage media and communication media.

As illustrated in the example of FIG. 4, electronic computing device 300 comprises a memory unit 302. Memory unit 302 is a computer-readable data storage medium capable of storing data and/or instructions. Memory unit 302 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, electronic computing device 300 comprises a processing unit 304. As mentioned above, a processing unit is a set of one or more physical electronic integrated circuits that are capable of executing instructions. In a first example, processing unit 304 may execute software instructions that cause electronic computing device 300 to provide specific functionality. In this first example, processing unit 304 may be implemented as one or more processing cores and/or as one or more separate microprocessors. For instance, in this first example, processing unit 304 may be implemented as one or more Intel Core 2 microprocessors. Processing unit 304 may be capable of executing instructions in an instruction set, such as the ×86 instruction set, the POWER instruction set, a RISC instruction set, the SPARC instruction set, the IA-64 instruction set, the MIPS instruction set, or another instruction set. In a second example, processing unit 304 may be implemented as an ASIC that provides specific functionality. In a third example, processing unit 304 may provide specific functionality by using an ASIC and by executing software instructions.

Electronic computing device 300 also comprises a video interface 306. Video interface 306 enables electronic computing device 300 to output video information to a display device 308. Display device 308 may be a variety of different types of display devices. For instance, display device 308 may be a cathode-ray tube display, an LCD display panel, a plasma screen display panel, a touch-sensitive display panel, a LED array, or another type of display device.

In addition, electronic computing device 300 includes a non-volatile storage device 310. Non-volatile storage device 310 is a computer-readable data storage medium that is capable of storing data and/or instructions. Non-volatile storage device 310 may be a variety of different types of non-volatile storage devices. For example, non-volatile storage device 310 may be one or more hard disk drives, magnetic tape drives, CD-ROM drives, DVD-ROM drives, Blu-Ray disc drives, or other types of non-volatile storage devices.

Electronic computing device 300 also includes an external component interface 312 that enables electronic computing device 300 to communicate with external components. As illustrated in the example of FIG. 4, external component interface 312 enables electronic computing device 300 to communicate with an input device 314 and an external storage device 316. In one implementation of electronic computing device 300, external component interface 312 is a Universal Serial Bus (USB) interface. In other implementations of electronic computing device 300, electronic computing device 300 may include another type of interface that enables electronic computing device 300 to communicate with input devices and/or output devices. For instance, electronic computing device 300 may include a PS/2 interface. Input device 314 may be a variety of different types of devices including, but not limited to, keyboards, mice, trackballs, stylus input devices, touch pads, touch-sensitive display screens, or other types of input devices. External storage device 316 may be a variety of different types of computer-readable data storage media including magnetic tape, flash memory modules, magnetic disk drives, optical disc drives, and other computer-readable data storage media.

In the context of the electronic computing device 300, computer storage media includes volatile and nonvolatile, removable and non-removable media implemented in any method or technology for storage of information such as computer readable instructions, data structures, program modules or other data. Computer storage media includes, but is not limited to, various memory technologies listed above regarding memory unit 302, non-volatile storage device 310, or external storage device 316, as well as other RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the electronic computing device 300.

In addition, electronic computing device 300 includes a network interface card 318 that enables electronic computing device 300 to send data to and receive data from an electronic communication network. Network interface card 318 may be a variety of different types of network interface. For example, network interface card 318 may be an Ethernet interface, a token-ring network interface, a fiber optic network interface, a wireless network interface (e.g., WiFi, WiMax, etc.), or another type of network interface.

Electronic computing device 300 also includes a communications medium 320. Communications medium 320 facilitates communication among the various components of electronic computing device 300. Communications medium 320 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

Communication media, such as communications medium 320, typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Electronic computing device 300 includes several computer-readable data storage media (i.e., memory unit 302, non-volatile storage device 310, and external storage device 316). Together, these computer-readable storage media may constitute a single data storage system. As discussed above, a data storage system is a set of one or more computer-readable data storage mediums. This data storage system may store instructions executable by processing unit 304. Activities described in the above description may result from the execution of the instructions stored on this data storage system. Thus, when this description says that a particular logical module performs a particular activity, such a statement may be interpreted to mean that instructions of the logical module, when executed by processing unit 304, cause electronic computing device 300 to perform the activity. In other words, when this description says that a particular logical module performs a particular activity, a reader may interpret such a statement to mean that the instructions configure electronic computing device 300 such that electronic computing device 300 performs the particular activity.

One of ordinary skill in the art will recognize that additional components, peripheral devices, communications interconnections and similar additional functionality may also be included within the electronic computing device 300 without departing from the spirit and scope of the present invention as recited within the attached claims.

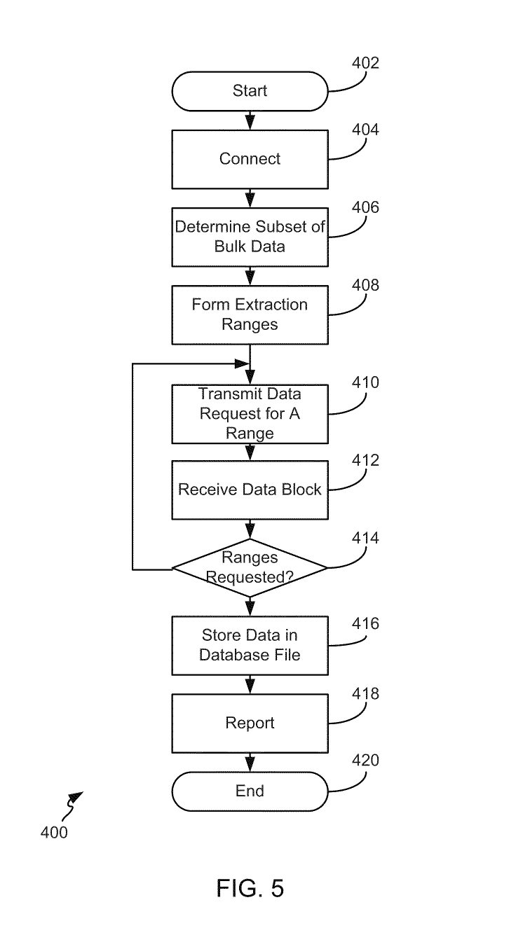

Referring now to FIG. 5, a flowchart of a method 400 providing automated transfer of block data is illustrated, according to a possible embodiment of the present disclosure. The method 400 is initiated at a start operation 402, which can, for example, be triggered as part of an automated process for transferring bulk data between two computing systems. In certain embodiments, the two computing systems could include an analysis computing system and a host computing system in some of the embodiments described herein.

A connection operation 404 connects a first computing system intending to request bulk data to a second computing system capable of providing the bulk data, such as information from a log file relating to workload operating statistics on a host computing system. A subset determination operation 406 determines a subset of the bulk data to be requested, and determines the number of data blocks associated with that subset. For example, if the bulk data at the computing system is organized by time, a continuous data block could be data associated with a predetermined length of time (e.g., four hours) with the overall subset of the bulk data corresponding to a number of the data blocks. Due to this relationship, it can be seen that the number of data blocks varies according to the size of the subset and the size of the data blocks.

An extraction range formation operation 408 forms extraction ranges to be associated with the subset determined at the subset determination operation 406. The extraction ranges correspond to requested portions of an event log of a predetermined size to form the subset requested. As previously explained, in certain embodiments, the extraction ranges are four hour periods of time in which workload operating statistics can be gathered at a host computing system. In other embodiments, the extraction ranges could be other predetermined criteria for separating bulk data into sections for transfer, indexing, and storage (using the methods and systems described herein).

A request operation 410 corresponds to transmitting a request from a first computing system to a second computing system. The request includes an identification of the first of the extraction ranges created using the extraction range formation operation 408. In certain embodiments, the identification of extraction range corresponds to an identification of a time range in an event log for which data is requested. A data block receipt operation 412 corresponds to receipt of a data block that corresponds to the portion of the bulk data within the extraction range. During the data block receipt operation 412, the data block can be assessed for errors, and one or more extraction tables can be updated to track the progress of the overall extraction and bulk data transfer process. For example, in certain embodiments, extraction table 124 described in connection with FIG. 3, above, could be used.

A range determination operation 414 determines whether all of the extraction ranges have been requested. For example, if a subset corresponds to one day of workload operating statistics, and extraction ranges are configured to relate to four hours of data, six data blocks will be requested. More or fewer blocks of data will be requested depending upon the amount of bulk data requested and the preconfigured size of the extraction ranges requested. If fewer than all of the extraction ranges have been requested, operation returns to the request operation 410 to request data associated with the next extraction range within the desired subset. If all of the extraction ranges have been requested within the subset, operation proceeds to a storage operation 416, which stores the returned data blocks into a database file (e.g., database file 102 of FIGS. 2-3). The storage operation 416 also indexes the data blocks as they are stored. In certain embodiments, operations 404-412 are managed by extraction module 122 of FIG. 3, above. Additionally, the storage operation 416 can be managed by, for example local database management module 126 of FIG. 3. Other embodiments are possible as well.

An optional report operation 418 allows creation of reports based on the stored data in the database file. In certain embodiments, the report operation 416 is executed from report module 128 of FIG. 3, and reports workload operating statistics relating to execution statistics of workloads on one or more host computing systems. Other embodiments are possible as well.

An end operation 418 signifies completed bulk data transfer and use of data, such as workload operating statistics, communicated between computing systems.

Referring to FIG. 5 generally, it is recognized that portions of the methods 400 described herein could be repeated as desired to request data blocks not successfully transferred during an initial data transfer process. Additionally, although the various operations are described in a particular order, no specific order is required with respect to the extraction of data blocks (e.g., the extraction ranges need not be addressed sequentially) due to tracking at the extraction table(s).

FIGS. 6-7 illustrate operation of a data extraction process 500 useable according to certain embodiments of the present disclosure. In the embodiments of FIGS. 6-7, the data extraction process is discussed in terms of extraction of bulk data in an event log at a host computing system for storage in an analysis computing system. The data extraction process 500 can be performed, for example, by the extraction module 122 of FIG. 3, or some equivalent system executing from a system requesting bulk data from a second, remote computing system. The data extraction process 500 is started at an initiation operation 502, which automatically triggers import of bulk data based on a predetermined schedule (for example, as programmed using user interfaces presented by the scheduling module 126 of FIG. 3).

A host name determination operation 504 determines the name of the host computing system to be connected to for retrieval of bulk data (e.g., from among a number of host computing systems accessible by the analysis computing system). A connection operation 506 attempts connection of the analysis computing system to the desired host computing system. A connection determination operation 508 determines whether the connection between the analysis computing system and host computing system was made successfully. If the connection was made successfully, operational flow proceeds to a service determination operation 510. If the connection was not made successfully, operation proceeds, via off page reference “B”, to FIG. 7, described below.

The service determination operation 510 determines whether a service is running properly at the host computing system. The service that is checked is generally a service that provides blocks of data in response to user requests. In certain embodiments, the service is a WLMSUPPORT service provided within the ClearPath MCP operating system. Other services could be used as well.

If the service determination operation 510 determines that the service has started and is currently operational at the host computing system, a binary statistics compatibility operation 512 queries the service to determine whether the host computing system is capable of delivering binary statistics data to the analysis computing system. The binary statistics compatibility operation 512 therefore determines whether the host computing system is capable of delivering the data blocks to the analysis computing system in response to requests from that system to the host computing system. If the binary statistics compatibility operation 512 determines that binary statistics can be delivered, an extraction range formation operation 514 forms the extraction ranges used to request a desired amount of data. The desired amount of data can be preselected when the overall process 500 is scheduled (e.g., using scheduling module 126 of FIG. 3). Extraction ranges can be formed based on subdividing the desired amount of data (e.g., the data collected since the last extraction, or some subset thereof) based on a predetermined extraction range and associated size of data block to be requested (e.g., a four hours extraction range). From the extraction range formation operation 514, operation proceeds, via off page reference “A”, to FIG. 7, described below. If the binary statistics compatibility operation 512 determines that binary statistics cannot be delivered, the bulk data transfer of FIGS. 6-7 cannot be accomplished, and operation proceeds, via off page reference “B”, to FIG. 7, described below.

If the service determination operation 510 determines that the service has not started at the host computing system, a failed counter operation 516 determines the number of times that starting the service was attempted. If the service was not attempted to be started two or more times, operation proceeds to a service start operation 518, which attempts to start the service capable of returning bulk data from the host computing system. If the service was already attempted to be started at least twice, the bulk data transfer of FIGS. 6-7 cannot be accomplished, and operation proceeds, via off page reference “B”, to FIG. 7, described below.

Referring now to FIG. 7, portions of the process 500 are illustrated, as continued from FIG. 6. Off-page reference “A” continues from the extraction range formation operation 514 of FIG. 6 in the instance where extraction can be performed (i.e., assessments performed by operations 508, 512, and 516 have not failed). Operation continues at extraction operation 520, which corresponds to a request and returned data block containing workflow operating statistics associated with an identified extraction range. The extraction operation 520 includes updating an extraction table based on the outcome of an extraction operation for a given extraction range, such that each extraction range and returned data block are associated with an entry in the extraction table identifying the status of that extraction (e.g., in progress, completed successfully, failed, etc.). The extraction table can take any of a number of forms, such as described above in connection with FIG. 3.

An extraction completion assessment operation 522 determines whether all extraction ranges that were formed have been requested and data blocks received. The extraction completion assessment operation 522 can, in certain embodiments, assess the completeness of a transaction based on information stored in an extraction table, as previously described. If not all extraction ranges are completed, operation returns to the extraction operation 520 for request and extraction of the next extraction range included in the bulk data to be acquired by the analysis computing system. If all extraction ranges are completed, operation proceeds to a notification operation 524, which notifies the user of the analysis computing system that the extraction has completed. The notification operation 524 can, in certain embodiments, occur based on assessment by the extraction module 122 of FIG. 3.

An import operation 526 imports all of the returned data blocks received during iterations of the extraction operation 520 into a database file at the analysis computing system. Each data block returned to the analysis computing system is indexed and stored in the schema of the database file. An import completion assessment operation 528 determines whether the import of the extracted data into the database file completed successfully. If the import has not yet completed, operation returns to the import operation 526. Once the import completes, operation continues to an import notification operation 528 which generates a message notifying the user of the successful import of the blocks of data representing the received extraction ranges into the database file. An extraction completion operation 532 corresponds to completed extraction of bulk data, including workload operating statistics, into the database file at the analysis computing system.

Referring to FIG. 7 generally, off-page reference “B” continues from a number of outcomes of the portion of process 500 included in FIG. 6 but where one or more of assessments performed by operations 508, 512, and 516 have failed. In these situations, one or more errors have occurred, and an extraction cannot take place. In such instances, user notification operation 534 notifies a user of an error occurring during the extraction. Various notifications could be generated depending upon the type of error observed that prevents completion of the extraction. For example, the extraction may not take place due to failure to start an extraction service on the host computing system, due to a host computing system's incompatibility with binary statistics extraction, or due to a failed connection to the host computing system. Operation proceeds from the user notification operation 534 to the completion operation 532, and the extraction process 500 halts operation.

Additionally, referring to FIGS. 6-7 generally, one or more instances of the process 500 can be completed with respect to different host computing systems on a given analysis computing system, such that any analysis computing system can receive bulk data extracted from a plurality of host computing systems. Furthermore, and referring to FIGS. 1-7 generally, although some embodiments of the bulk data disclosed herein relates to workload operation, other types of bulk data can be aggregated and transferred as well using the methods and systems described herein. For example, the methods and systems for bulk data transfer disclosed herein could be used in other circumstances in which intermittent data connections cause errors or other interruptions in bulk data transfers. In such instances, tracked extraction ranges allow a requesting computing system to only retry transfer of blocks for which transfer failed. Additionally, although preferred embodiments operate by using an automated, scheduled extraction process, it is recognized that manual extraction can use the extraction ranges and serial, discrete data blocks described herein.

The above specification, examples and data provide a complete description of the manufacture and use of the composition of the invention. Since many embodiments of the invention can be made without departing from the spirit and scope of the invention, the invention resides in the claims hereinafter appended.

1. A method of transferring bulk data comprising:
communicatively connecting a first computing system to a second computing system, the second computing system storing bulk data;
determining a subset of the bulk data to be requested by the first computing system;
forming one or more extraction ranges representing the subset of the bulk data; and
for each of the one or more extraction ranges:
transmitting a request for data from the first computing system to the second computing system, the request for data including an identification of the extraction range; and
receiving a data block from the second computing system, the data block defined by the extraction range and extracted from the bulk data.

2. The method of claim 1, wherein the bulk data comprises a log file including workload operation statistics of the second computing system.

3. The method of claim 2, wherein the log file is organized by time, and wherein each of the extraction ranges represent time ranges of a predetermined length of time.

4. The method of claim 1, wherein the second computing system is a host computing system, and wherein the first computing system is an analysis computing system.

5. The method of claim 1, further comprising, for each of the extraction ranges, upon receiving the data block, updating a table managed by the first computing system, the table tracking receipt of the one or more extraction ranges at the first computing system.

6. The method of claim 1, wherein communicatively connecting a first computing system to a second computing system, occurs upon a predetermined schedule set by the first computing system.

7. The method of claim 1, further comprising verifying the ability of the second computing system to provide binary data to the first computing system.

8. The method of claim 1, further comprising sending an initialize command to the second computing system, the initialize command capable of initializing a data export service operable at the second computing system to extract the data block to the first computing system.

9. The method of claim 1, further comprising, for each of the one or more extraction ranges, storing the data block in a database file managed at the first computing system.

10. The method of claim 1, further comprising generating one or more reports based on the information stored in the database file.

11. The method of claim 1, further comprising, upon determining that a data block associated with one of the one or more extraction ranges was not returned successfully, transmitting a second request for data from the first computing system to the second computing system, the second request for data including an identification of the extraction range associated with the data block that was not returned successfully.

12. A system for obtaining data from a host computing system, the system comprising:
an analysis computing system communicatively connected to the host computing system, the analysis computing system including a memory configured to store one or more database files, the analysis computing system configured to:
communicatively connect the analysis computing system to the host computing system, the host computing system storing bulk data;
determine a subset of the bulk data to be requested system;
form one or more extraction ranges representing the subset of the bulk data; and
for each of the one or more extraction ranges:
transmit a request for data to the host computing system, the request for data including an identification of the extraction range;
receive a data block from the host computing system, the data block defined by the extraction range and extracted from the bulk data; and
upon receipt of all of the data blocks from the host computing system, store the data blocks in the database file.

13. The system of claim 12, further comprising an extraction table stored in the memory of the analysis computing system, wherein, upon receipt of each data block from the host computing system, the analysis computing system is configured to update an entry in the extraction table.

14. The system of claim 12, wherein the bulk data includes workload operation statistics relating to workloads executing on the host computing system.

15. The system of claim 12, wherein the database file has a schema arranged by record type and indexed by timestamp.

16. The system of claim 12, further comprising a scheduler operable on the analysis computing system, the scheduler configured to allow creation of a schedule to communicatively connect the analysis computing system to the host computing system.

17. The system of claim 12, wherein the analysis computing system is further configured to generate one or more reports based on at least a portion of the information stored in the database file.

18. A system for obtaining data relating to workload operation statistics comprising:
a plurality of host computing systems each storing a log file of workload operation statistics of that host computing system;
an analysis computing system communicatively connected to the plurality of host computing systems, the analysis computing system including a memory configured to store one or more database files, the analysis computing system configured to:
communicatively connect to each of the plurality of host computing systems, each host computing system storing a log file including workload operation statistics;
determine a subset of the workload operation statistics to be requested from each of the host computing systems;
form one or more extraction ranges representing the subset of the workload operation statistics for each host computing system; and
for each of the one or more extraction ranges and each of the host computing systems:
transmit a request for data to the host computing system, the request for data including an identification of the extraction range;
receive a data block from the host computing system, the data block defined by the extraction range and extracted from the log file; and
store the data block in a database file at the analysis computing system, the database file thereby containing workload operation statistics for a plurality of host computing systems.

19. The system of claim 18, further comprising a scheduler operable on the analysis computing system, the scheduler configured to allow creation of a schedule to communicatively connect the analysis computing system to the host computing system.

20. The system of claim 19, further comprising a reporting module operable on the analysis computing system and configured to generate reports based on at least a portion of the workload operating statistics stored in the database file.
